(19) United States
(12) Patent Application Publication
(10) Pub. No.: US 2009/0025265 A1
(43) Pub. Date: Jan. 29, 2009

(54) Self-standing collapsible portable structure

(75) Inventor: Maya P. Jedlicka, Plano, TX (US)

Correspondence Address: DOCKET CLERK, P.O. DRAWER 800889, DALLAS, TX, 75380, US

(73) Assignee: PACATLANTIC ENTERPRISES, L.L.C., Plano, TX (US)

(21) Appl. No.: 12/151,708

(22) Filed: May 8, 2008

Related U.S. Application Data
(63) Continuation-in-part of application No. 11/999,437, filed on Dec. 5, 2007.
Application No. 11/999,437 is a continuation-in-part of application No. 11/496,752, filed on Aug. 1, 2006.
(60) Provisional application No. 60/704,481, filed on Aug. 1, 2005.

(51) Int. Cl. G09F 15/00

(52) U.S. Cl. 40/610

(57) ABSTRACT

A collapsible portable structure employs elongate side panels of a generally trapezoidal shape and has an overall height of between about 12 and about 36 inches in an expanded state and an aspect ratio of about 1.1:1 to about 1.5:1. Each panel is not more than about 21 inches wide at the widest point and may include upper and lower mesh portions, a central message-bearing portion and an optional reflective strip. Corner panels between bottom edges of adjacent side panel contain weighting material therein to improve stabilization. A top panel may be formed of a mesh material and include a central grommet.

### CROSS-REFERENCE TO RELATED APPLICATIONS

The present application claims priority as a continuation-in-part of co-pending U.S. patent application Ser. No. 11/999,437 filed on Dec. 5, 2007 and entitled “IMPROVED SELF-STANDING COLLAPSIBLE PORTABLE STRUCTURE AND METHOD,” as a continuation-in-part of co-pending U.S. patent application Ser. No. 11/496,752 filed on Aug. 1, 2006 and entitled “SELF-STANDING COLLAPSIBLE PORTABLE STRUCTURE AND METHOD,” and through that application claims the benefit of the earlier filing date of U.S. Provisional Patent Application Ser. No. 60/704,481 also entitled “SELF-STANDING COLLAPSIBLE PORTABLE STRUCTURE AND METHOD” and filed Aug. 1, 2005, and as a continuation-in-part of U.S. Design patent application Ser. No. 29/294,246 entitled “FLOOR SIGN” and filed Dec. 28, 2007, which is a continuation of U.S. Design patent application Ser. No. 29/235,283 also entitled “FLOOR SIGN” and filed Jul. 29, 2005 (now US D558,832). The content of the above-identified patent documents is hereby incorporated by reference.

### TECHNICAL FIELD

The present disclosure is directed, in general, to self-standing portable structures and, more specifically, to collapsible self-standing portable structures serving as warning markers and the like.

### BACKGROUND

Self-standing portable structures for cautionary, warning or alert purposes have generally taken the form of fixed structures, such as roadway traffic cones, that are bulky and present storage problems even when the structures are capable of nesting. Efforts to develop collapsible self-standing portable structures have resulted in unsatisfactory designs that suffered from several deficiencies. Common drawbacks associated with such designs have included difficulty or complexity in erecting the structures, mechanical component unreliability or failure (particularly in spring-biased designs), and stability of the structure after erection. Such structures also tend to be mechanically complicated, making them expensive to manufacture and troublesome to collapse For storage. In general, the size, weight, complexity and bulkiness—even in a collapsed state—of most self-standing portable structures make them difficult to carry and quickly deploy or to easily collapse and/or conveniently store. Thus, the existing designs of self-standing portable structures used to provide information, such warnings, advertisements, and/or general content, have not been successful in providing a simple structure that is inexpensive to manufacture, compact for storage and transportation, lightweight and easy to carry, quick and easy to erect, and quick and easy to collapse.

There is, therefore, a need in the art for improved collapsible self-standing portable structures.

### SUMMARY

To address the above-discussed deficiencies of the prior art, it is a primary object of the present disclosure to provide, for use in providing a structure to display an alert or warning message, a collapsible portable structure that employs elongate side panels of a generally trapezoidal shape and has an overall height of between about 12 and about 36 inches in an expanded state, with an aspect ratio of about 1.1:1 to about 1.5:1. Each panel is not more than about 21 inches wide at the widest point and may include upper and lower mesh portions, a central message-bearing portion and an optional reflective strip. Corner panels between bottom edges of adjacent side panel contain weighting material therein to improve stabilization. A top panel may be formed of a mesh material and include a central grommet.

The foregoing has outlined rather broadly the features and technical advantages of the present disclosure so that those skilled in the art may better understand the detailed description that follows. Additional features and advantages will be described hereinafter that form the subject of the claims. Those skilled in the art will appreciate that they may readily use the conception and the specific embodiment disclosed as a basis for modifying or designing other structures for carrying out the same purposes. Those skilled in the art will also realize that such equivalent constructions do not depart from the spirit and scope of this disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; and the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, and those of ordinary skill in the art will understand that such definitions apply in many, if not most, instances to prior as well as future uses of such defined words and phrases.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 is a perspective view of an improved collapsible portable structure according to one embodiment of the present disclosure in an expanded state;

FIG. 2 is a top (plan) view of an improved collapsible portable structure according to one embodiment of the present disclosure in an expanded state;

FIG. 3 is a bottom view of an improved collapsible portable structure according to one embodiment of the present disclosure in an expanded state;

FIG. 4 depicts an improved collapsible portable structure according to one embodiment of the present disclosure in a partially collapsed state;

FIG. 5 is a perspective view of an improved collapsible portable structure according to one embodiment of the present disclosure in a fully collapsed state;

FIGS. 6A and 6B are sketches illustrating the dimensions of the improved collapsible portable structure of FIGS. 1 through 5 in an expanded state;

FIG. 7 is a top (plan) view of an improved collapsible portable structure according to an alternative embodiment of the present disclosure in an expanded state;

FIG. 8 is a more detailed view of a portion of an improved collapsible portable structure according to an alternative embodiment of the present disclosure;

FIG. 9 is a perspective view of an improved collapsible portable structure according to another embodiment of the present disclosure in an expanded state;

FIGS. 10A and 10B depict a more detailed view of a portion of the improved collapsible portable structure of FIG. 9;

FIG. 11 is a sketch illustrating the dimensions of the improved collapsible portable structure of FIG. 9 in an expanded state;

FIG. 12 is a perspective view of an improved collapsible portable structure according to still another embodiment of the present disclosure in an expanded state;

FIGS. 13A and 13B are sketches illustrating the dimensions of the improved collapsible portable structure of FIG. 12 in an expanded state;

FIG. 14 is a perspective view of an improved collapsible portable structure according to yet another embodiment of the present disclosure in an expanded state; and

FIG. 15 is a sketches illustrating the dimensions of the improved collapsible portable structure of FIG. 14 in an expanded state.

### DETAILED DESCRIPTION

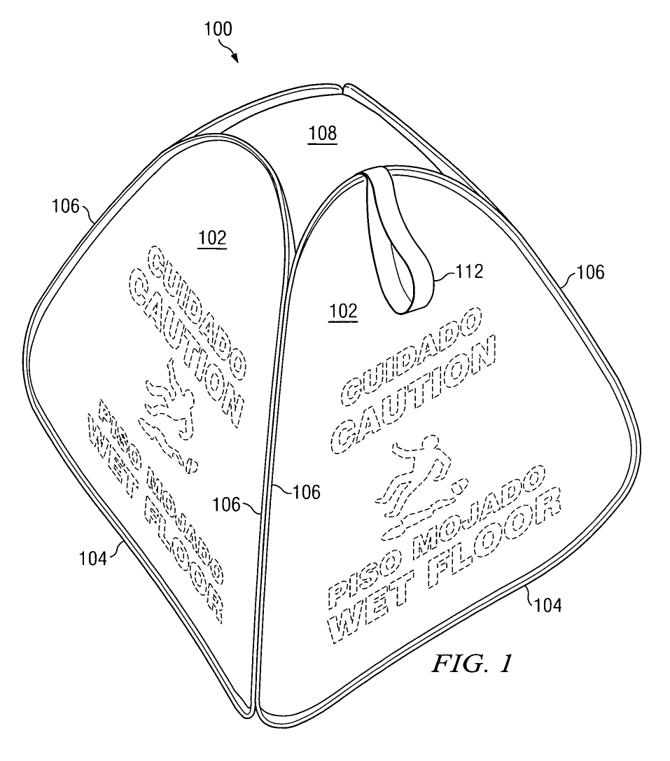

FIGS. 1 through 15, discussed below, and the various embodiments used to describe the principles of the present invention in this patent document are by way of illustration only and should not be construed in any way to limit the scope of the disclosure. Those skilled in the art will understand that the principles of the present invention may be implemented in any suitably arranged device.

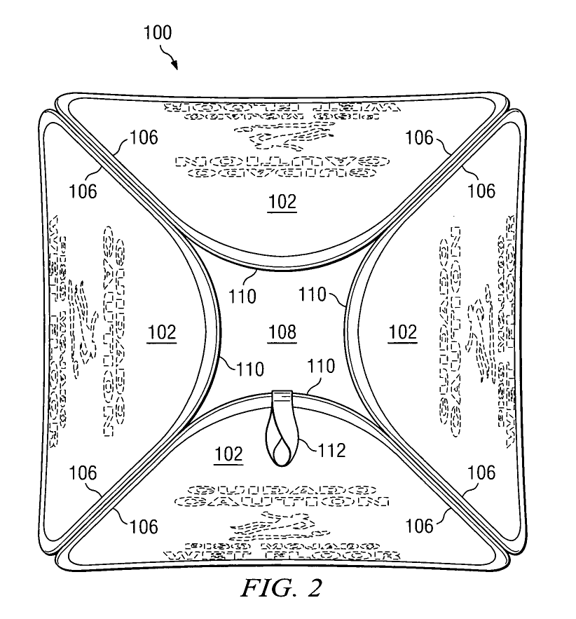

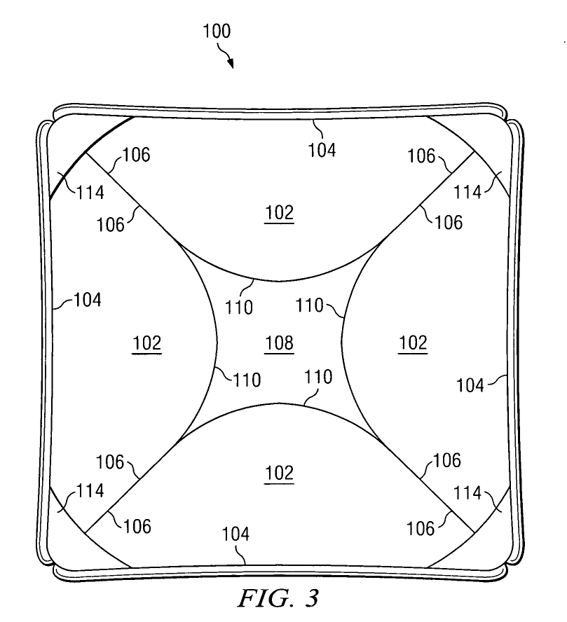

FIG. 1 is a perspective view, FIG. 2 is a top (plan) view, and FIG. 3 is a bottom view of an improved collapsible portable structure according to one embodiment of the present disclosure. Collapsible portable structure 100 includes, in the exemplary embodiment, four elongate side panels 102 that are substantially identical in size and shape, generally triangular with rounded corners and each having a bottom edge 104 and two side edges 106 that are of equal length but longer than the bottom edge 104. Adjacent pairs of side panels 102 are connected or attached along at least a portion of the respective side edges 106 for those panels. The collapsible portable structure 100, in a non-collapsed or expanded state, is intended to rest generally on the bottom edges 104 of the side panels 102. The collapsible portable structure 100 in a non-collapsed or expanded state forms a pyramidal frustum.

Collapsible portable structure 100 is configured such that, in an expanded (i.e., deployed) or non-collapsed position, the elongate side panels 102 are connected or held together along the side edges 106 to form an interior space defined by the side panels 102 with an open bottom. As described in the prior applications identified above, side panels 102 are preferably each formed with a folded piece of fabric trim around an entire periphery of the respective side panel, where the folded fabric trim forms a retaining sleeve for holding a flexible frame member (not shown) therein. Each side panel 102 is preferably formed from a flexible, water-resistant fabric that substantially covers a space defined by the respective frame member and retaining sleeve, and which preferably includes text, graphics or both on at least a central region thereof.

The frame member within each side panel 102 is biased to expand outwardly and is constrained by the fabric of the side panel 102 and retaining sleeve/trim, which forms three long segments connected by curved portions in a generally triangular or trapezoidal shape having curved or rounded bottom corners and a curved or rounded top. The fabric or side panel 102 and the retaining sleeve or trim may be formed from the same material, although different colors may be used with the fabric preferably being a bright color such as a fluorescent orange, yellow or red. Each side panel 102 includes an alert or warning message in a central portion of the fabric thereof, including graphics, text or both. The frame member within the retaining sleeve/trim of each side panel 102 is preferably flat, with a rectangular cross-section, and formed from a flexible, elastic material such as metal or plastic.

The retaining sleeves/trim and the edges of the fabric for each side panel 102 are sewn together around a periphery thereof, and the side edges 104 of each of two adjacent side panels 102 are sewn together along a portion thereof to join the adjacent panels along those side edges. Along other portions of the periphery of a side panel 102, the retaining sleeve and fabric are similarly sewn together, but without being sewn to the retaining sleeve or fabric for an adjacent side panel 102.

Collapsible portable structure 100 may include optional top panel 108 between and interconnecting the top edges 110 of side panels 102, sewn together with the retaining sleeve 108 and fabric of the side panels 102 as described above for adjacent side panels. Optionally, a flexible retaining strap 112 may be attached to the top portion of one of the side panels for use in holding and retaining collapsible portable structure 100 in the generally-cylindrical shape when in the collapsed state, as described in further detail below. Collapsible portable structure 100 may also optionally include corner panels 114 between the side and bottom edges of adjacent side panels 102, also sewn together with the retaining sleeve and fabric of the side panels 102 as described above for adjacent side panels.

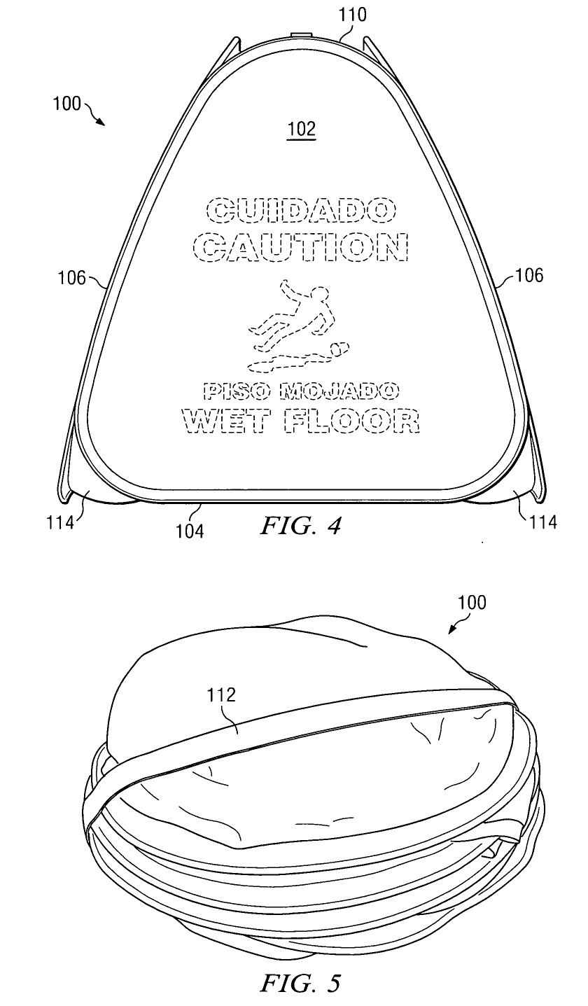

FIGS. 1 through 3 depict the collapsible portable structure in a deployed or non-collapsed position or state. Collapsible portable structure 100 is further configured to transition from the expanded or non-collapsed position into a collations position, in which the collapsible portable structure 100 has a compact generally cylindrical shape that is reduced in size. The collapsible portable structure 100 is altered from the expanded or non-collapsed state to the collapsed state in substantially the same manner as described in the above-identified patent documents. That is, the portable structure 100 is collapsed by folding the structure in on itself at one pair of side edges, by pushing in a first edge between two adjacent side panels such that the interior space defined by the side panels 102 in the expanded position is substantially eliminated, and pushed-in edge is proximate to a second edge between two adjacent side panels, where the first and second edges are located diagonally opposite each other when the structure 100 is in the expanded position. Two pairs of “stacked” side panels are thus formed, and those pairs of side panels are then folded together so that a single “stack” of side panels is formed, as shown in FIG. 4. The stacked side panels are then simultaneously twisted and folded, with one corner of the stacked panels rotated 360° relative to another corner while being folded over and laterally twisted (that is, rotated around) to overlie that other corner, so that all three corner regions of the side panels overlie each other, forming a generally cylindrically-shaped collapsed structure as shown in FIG. 5. Retaining strap 112 holds the collapsible portable structure 100 in the collapsed position. The collapsible portable structure 100 is restored to the expanded or non-collapsed state in essentially the opposite manner from collapsing the structure described above.

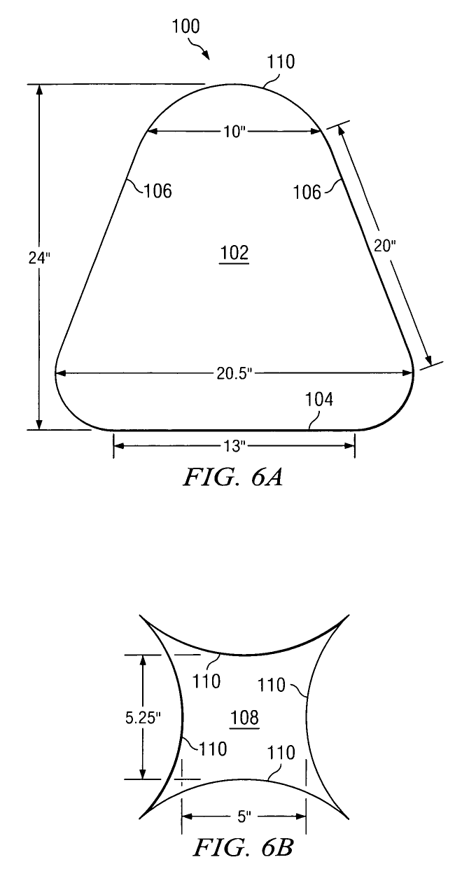

FIGS. 6A and 6B are sketches illustrating the dimensions of an improved collapsible portable structure according to one embodiment of the present disclosure in an expanded state. Collapsible portable structure 100 has an overall height of about 24 inches. The side panels 102 are sewn together for a length of about 20 inches along the side edges 106, and are about 10 inches in width at a top point where the side edges 106 diverge and about 20.5 inches in width at the bottom point where the side edges 106 diverge. The top edges 110 have a minimum separation of about 5 inches in one direction and about 5.25 inches in another direction (allowing the stack configuration of the side panels to be achieved). Collapsible portable structure 100 collapses into a structure about 9 inches in diameter by about 2.5 to 3 inches thick.

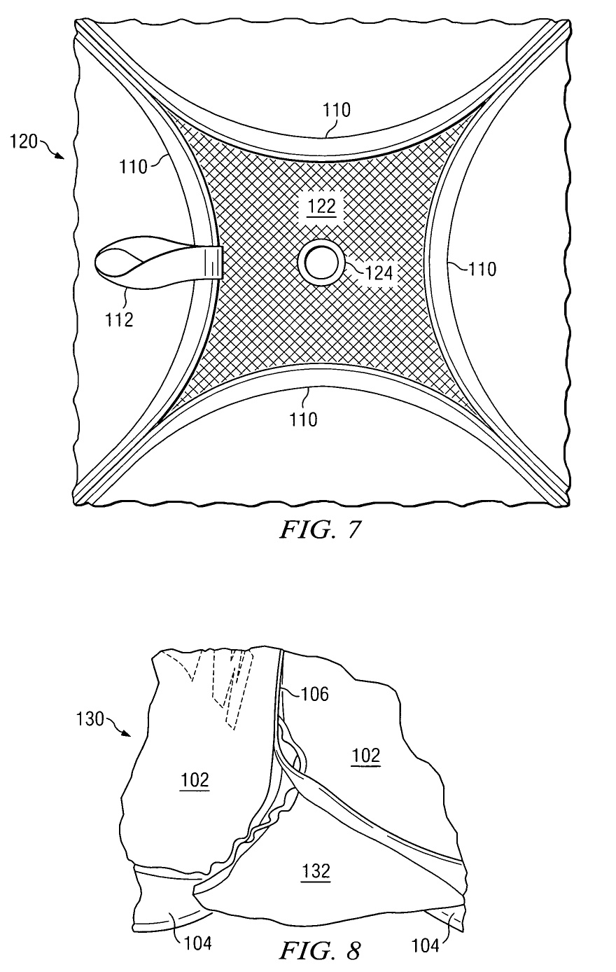

FIG. 7 is a top (plan) view of an improved collapsible portable structure according to an alternative embodiment of the present disclosure in an expanded state. Collapsible portable structure 120 is similar to collapsible portable structure 100 except that the top panel 122 top panel 108 between and interconnecting the top edges 110 of the side panels 102 is formed of a mesh material, and includes a grommet 124 centered therein. The mesh material (i.e., a-loosely woven or plastic fabric that has a large number of closely-spaced holes) of the top panel 122 allows the passage of air therethrough such that drafts of air are less likely to move the portable collapsible structure 120. Grommet 124 allows insertion of a light, such as a chemically activated disposable light or a small flashing light, or use of a center pole or stake to support the collapsible portable structure 120 or to secure collapsible portable structure 120 at a given location.

FIG. 8 is a more detailed view of a portion of an improved collapsible portable structure according to an alternative embodiment of the present disclosure. Collapsible portable structure 130 includes a corner panel 132 that is filled with weighting material. In an exemplary embodiment, the weighting material are small pellets or beads, such a polypropylene pellets, although alternatively sand, small shot, or small ball bearings may be used, or some other material that, when enclosed in fabric, allows the fabric and weight material enclosed therein to be folded and/or otherwise deformed. Although only one corner panel is depicted, each of the four corner panels between the side edges 104 and bottom edges 106 of adjacent side panels 102 has a quantity of the weighting material therein in the exemplary embodiment. This allows collapsible portable structure to withstand gusts of wind and the like without movement. A collapsible portable structure may include either or both of the mesh top panel described above and weighted corner panels.

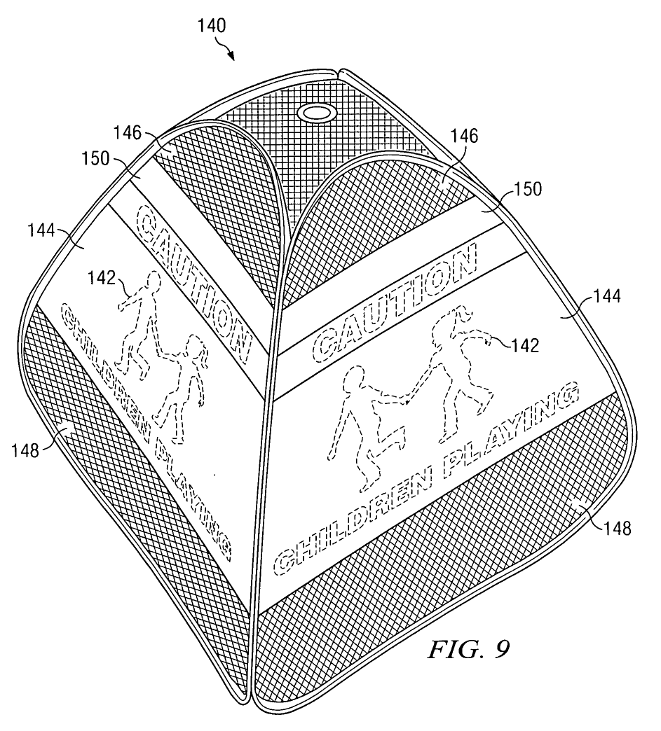

FIG. 9 is a perspective view of an improved collapsible portable structure according to still another embodiment of the present disclosure in an expanded state. Collapsible portable structure 140 is constructed and collapses/expands in the same manner as, and includes the features of, the collapsible portable structures 100, 120 and 130 described above, except for the differences is described below. Each side panel 142 in collapsible portable structure 140 includes a central message-bearing fabric panel 144 of the same type of waterproof material employed for side panels 102. However, each side panel 142 also includes an upper mesh region 146 and a lower mesh region 148. Use of mesh fabric regions in this manner will allow passage of air through the side panels and reduce the likelihood of tipping, particularly when the collapsible portable structure 140 is weighted in the corner panels as described above. In one embodiment, the entire body of each side panel 142 may be formed from a mesh fabric material, with attachment structures such as Velcro provided to retain a detachable fabric message-bearing panel 144 in a central area of each side panel. The use of mesh fabric in at least peripheral portions of the side panels 142, between the retaining sleeve and a central message-bearing region, will reduce the amount of weight required to stabilize the structure. The top panel is also formed of the mesh fabric material in the exemplary embodiment of collapsible portable structure 140. In the example shown, each side panel 142 also includes an optional reflective strip 150 between the upper mesh portion 146 and the central message-bearing fabric panel 144.

Collapsible portable structure 140 is intended for outdoor as well as indoor use. As such, the elongate nature of the structure 140 makes that structure susceptible to tipping over as a result of weather conditions such as wind or from gusts of air caused by passing vehicles. While a base (determined by the width of the side panels at their widest point) that is wide relative to the overall height of the collapsible portable structure could reduce the possibility of such tipping, using a wider base would require a larger “footprint” (area occupied) for a portable structure having sufficient height so as not to constitute a tripping hazard. For that reason, collapsible portable structure 140 includes weighted corner panels as described above. Alternatively, the weighting material may be in pockets or tubes sewn intermittently or continuously along the bottom edge of each side panel. Preferably, however, the weighting material is contained within the corner panels since such placement achieves stabilization with less weight than alternative placement of the weighting material, and also presents a minimal impediment to collapsing the structure. The amount of weight should be selected to prevent tipping is of the collapsible portable structure 140 under normal outdoor conditions.

For outdoor use of the collapsible portable structure 140, stake down holes may also be provided near the bottom edge of each of corner panel, or a stake-down loop may be affixed to corner panels or to the bottom edge of each side panel 142. A simple reinforced hole or grommet or short fabric loop receiving a metal or plastic stake for assisting in stabilizing the collapsible portable structure 140 and retaining the structure in place may be provided as described. The fabric loop may be sufficiently large to allow use of a weight (e.g., a rock or brick) to assist in holding the portable structure in place. The grommet the top panel of collapsible portable structure 140 may also allow the portable structure 140 to be staked down to the ground (during outdoor use) from the top.

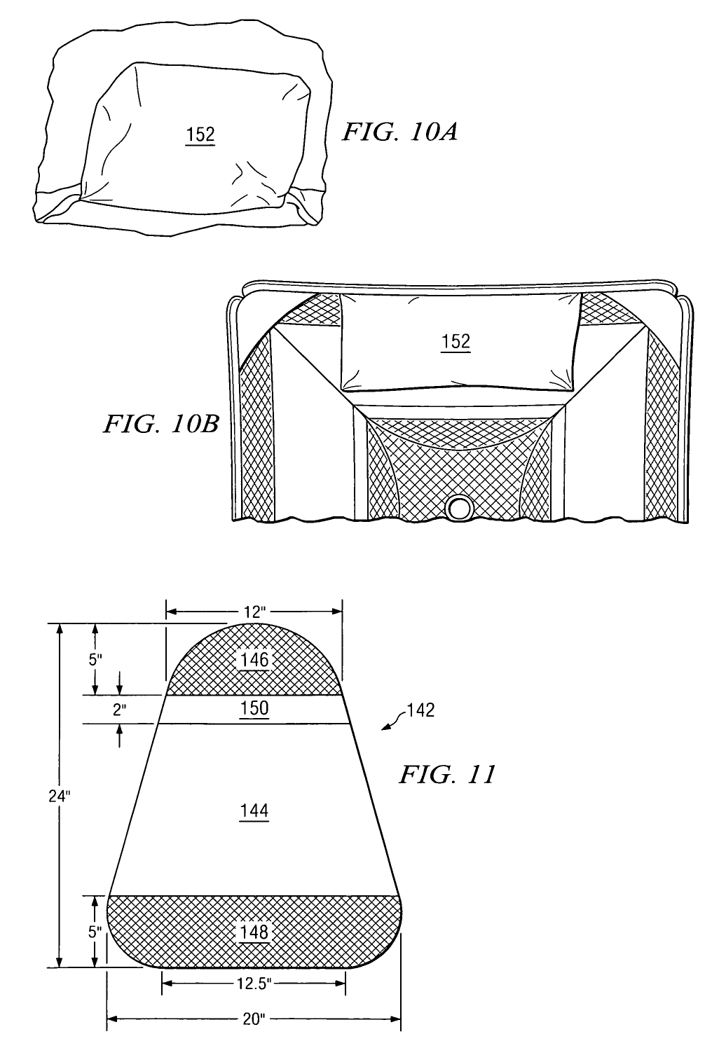

FIGS. 10A and 10B depict a more detailed view of a portion of the improved collapsible portable structure of FIG. 9. Collapsible portable structure 140 includes an optional rectangular pocket sewn 152 centered on and sewn to a bottom edge of one or more of the side panels. The pocket 152 is preferably a piece of folded over material with the sides sewn closed and the edges opposite the fold forming an opening, one edge sewn to the bottom edge of a side panel and the other edge offset therefrom. Weights such as rocks or bricks may be inserted into pocket 152. Such pockets may be provided for one, two, three or all of the side panels of collapsible portable structure 140.

FIG. 11 is a sketch illustrating the dimensions of the improved collapsible portable structure of FIG. 9 in an expanded state. Like collapsible portable structures 100, 120 and 130, collapsible portable structure 140 has an overall height of about 24 inches. The upper mesh portion 146 forms about the top 5 inches of side panel 142, and lower mesh portion 148 forms about the bottom 5 inches. The reflective strip 150 is about 2 inches wide. The center message-bearing portion 144 in the exemplary embodiment is about 12 inches wide at the top (adjacent reflective strip 15) and about 20 inches wide at the bottom (adjacent lower mesh portion 148). The bottom edges of the side panel are about 12 inches wide. The top panel has the same dimensions depicted in FIG. 6B, but is preferably mesh with a center grommet.

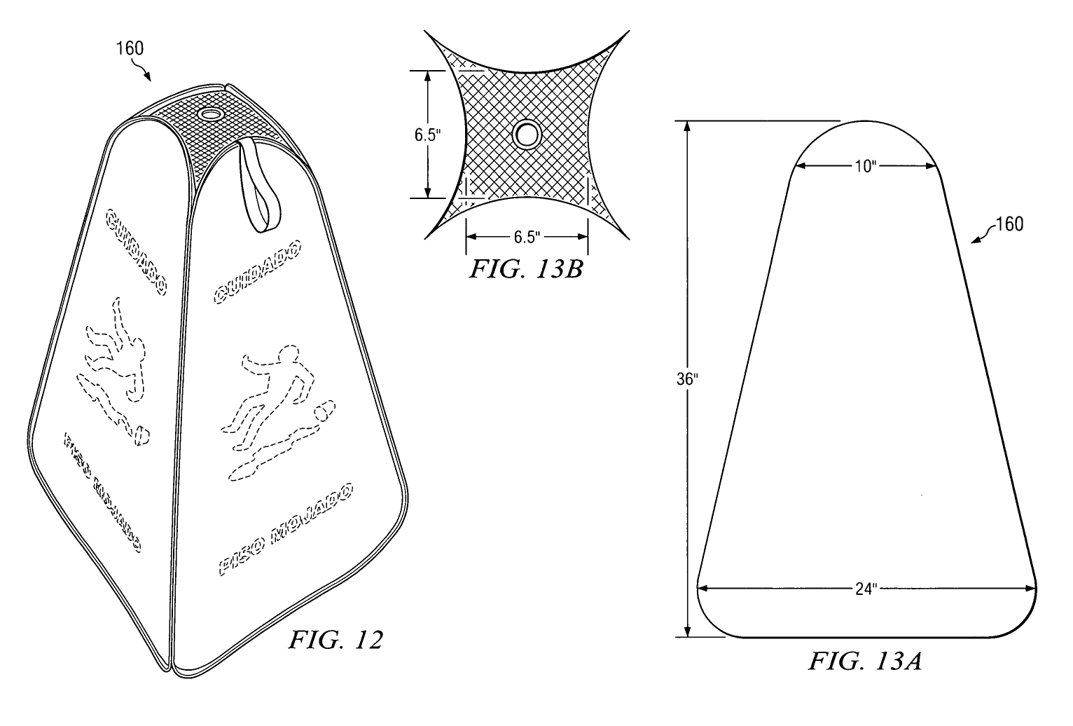

FIG. 12 is a perspective view of an improved collapsible portable structure according to still another embodiment of the present disclosure in an expanded state. FIGS. 13A and 13B are sketches illustrating the dimensions of the improved collapsible portable structure of FIG. 12 in an expanded state. Collapsible portable structure 160 is constructed in much the same manner as collapsible portable structure 100, with side panels each formed by frame members, retaining sleeves and flexible fabric and sewn together along edges thereof. However, collapsible portable structure 160 preferably has an overall height of about 36 inches, with each side panel having a maximum width of about 24 inches and a width near the top of about 10 inches. The top panel (mesh with a central grommet) has a minimum width of about 6.5 inches in each direction. Collapsible portable structure 160 is thus less of a tripping hazard. Weighted corner panels as described above inhibit tipping. Collapsible portable structure 160 does not necessary fully collapse into a small cylinder as does collapsible portable structure 100 (as depicted in FIG. 5), but does partially collapse into a set of stacked side panels similar to those depicted in FIG. 4.

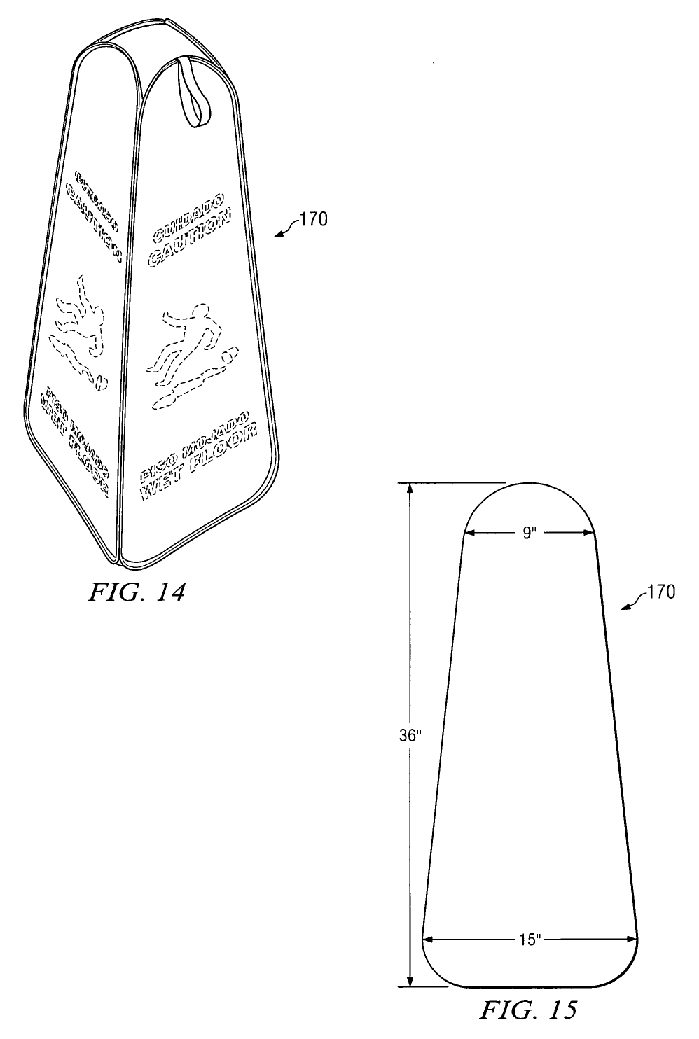

FIG. 14 is a perspective view of an improved collapsible portable structure according to yet another embodiment of the present disclosure in an expanded state. FIG. 15 is a sketch illustrating the dimensions of the improved collapsible portable structure of FIG. 14 in an expanded state. Collapsible portable structure 170 is also constructed in much the same manner as collapsible portable structure 100, with side panels each formed by frame members, retaining sleeves and flexible fabric and sewn together along edges thereof. Collapsible portable structure 170 also has an overall height of about 36 inches, but with side panels of only a maximum width of 15 inches and a width near the top of only 9 inches. The top panel configuration and dimensions match those for collapsible portable structure 160. Like collapsible portable structure 160, collapsible portable structure 170 does not necessarily fully collapse, but does at least collapse into a set of stacked side panels. Weighted corner panels inhibit tipping.

The elongate shape of each of the collapsible portable structures described above produces an overall height for the portable structure that is sufficient to avoid having the respective portable structure constitute a tripping hazard, while occupying an acceptable footprint of surface area. The elongate shape provides an aspect ratio, defined by the total height of the collapsible portable structure relative to a maximum width of any of the side panels, of about 1.1:1 to about 1.5:1. The total height may be varied anywhere between about 12 inches and about 36 inches depending upon the application. As previously noted, a height greater than about 21 inches avoids the collapsible portable structure being classified as a tripping hazard. However, and embodiment similar to that depicted in FIG. 12 but with an overall height of about 16 inches and a maximum side panel width of about 10 to 11 inches is useful in certain situations. The elongate shape of the side panels, formed by isosceles triangles in which the bottom edge is shorter than the side edges, results in a structure that has been found to be more recognizable as a warning sign (or “cone”) to people than a structure in which the side panels are formed by substantially equilateral triangles. However, the more elongate the structure, the less likely that the structure can be folded into a cylindrical shape. Accordingly, tradeoffs must be made between the elongate shape (high aspect ratio) of the collapsible portable structure, improving recognition of the structure as a warning marker, and the ability to collapse the structure into as small and compact of a shape as possible, facilitating transportation and storage.

Weights within or affixed to the corner panels between bottom corners of the side panels provide stabilization without adding undue weight to the overall structure. The weighted bottom and other optional features such as mesh fabric in perimeter portions of each side panel allow the collapsible portable structure to be employed outdoors without risk of movement by normal winds and the like.

Although the present invention has been described in detail, those skilled in the art will understand that various changes, substitutions, variations, enhancements, nuances, gradations, lesser forms, alterations, revisions, improvements and knock-offs of the invention disclosed herein may be made without departing from the spirit and scope of the invention in its broadest form.

What is claimed is:

1. A collapsible portable structure comprising:
four elongate, generally trapezoidal panels, each panel attached at side edges thereof to two adjacent panels within the portable structure,
each panel including a flexible frame member extending around a periphery of the panel and one or more pieces of resilient material affixed to the frame member and collectively substantially covering a region interior to the frame member,
wherein the collapsible portable structure has an overall height of at least about 24 inches in an expanded state and wherein each panel has a maximum width of about 20 to 21 inches.

2. The collapsible portable structure of claim 1, wherein the one or more pieces of resilient material for each panel comprise upper and lower mesh portions and a central message-bearing portion.

3. The collapsible portable structure of claim 2, wherein the one or more pieces of resilient material are each fabric.

4. The collapsible portable structure of claim 2, wherein the one or more pieces of resilient material for each panel further comprise a reflective strip.

5. The collapsible portable structure of claim 1, wherein each central message-bearing region contains text, graphics or both.

6. The collapsible portable structure of claim 1, wherein each panel is hingedly attached to the two adjacent panels to allow the four panels to be folded into a generally stacked arrangement.

7. A collapsible portable structure comprising:
four elongate, generally trapezoidal panels, each panel including:
a flexible frame member extending around a periphery of the panel; and
resilient material affixed to the frame member and substantially covering a region interior to the frame member, the resilient material including upper and lower mesh portions and a central message-bearing portion.

8. The collapsible portable structure of claim 7, wherein each panel is hingedly attached at side edges thereof to two adjacent panels within the portable structure, and wherein the four panels are adapted to transition between an expanded position in which the four panels form a generally pyramidal structure to a collapsed position in which the four panels form a generally cylindrical structure.

9. The collapsible portable structure of claim 7, wherein the frame member within each panel biases the panel to the substantially planar state.

10. The collapsible portable structure of claim 7, wherein corner regions of the panel in the substantially planar state overlie each other in the substantially cylindrical state.

11. The collapsible portable structure of claim 7, wherein the four panels are folded into a generally stacked arrangement during transition of the portable structure between the expanded and collapsed positions.

12. The collapsible portable structure of claim 11, wherein the four panels are shifted from the generally stacked arrangement into the substantially cylindrical state by concurrently twisting and rotating corner regions of the panels relative to other corner regions of the panels.

13. The collapsible portable structure of claim 7, wherein central message-bearing portion bears text, graphics or both.

14. A collapsible portable structure comprising:
four elongate, generally trapezoidal panels, each panel including:
a flexible frame member extending around a periphery of the panel; and
a resilient material affixed to the frame member and substantially covering a region interior to the frame member,
wherein each panel is hingedly attached at side edges thereof to two adjacent panels within the portable structure; and
corner panels between corners of adjacent panels at bottom edges of the panels, each corner panel including a weighting material therein,
wherein the collapsible portable structure has an overall height of at least about 36 inches in an expanded state.

15. The collapsible portable structure of claim 14, further comprising:
a top panel between corners of the panels opposite the bottom edges, the top panel formed of a mesh material and including a central grommet.

16. A collapsible portable structure comprising:
four elongate, generally trapezoidal panels, each panel including:
a flexible frame member extending around a periphery of the panel; and
a resilient material affixed to the frame member and substantially covering a region interior to the frame member,
wherein each panel is hingedly attached at side edges thereof to two adjacent panels within the portable structure, and
wherein the collapsible portable structure, in an expanded state, has an overall height of about 16 inches and an aspect ratio of between about 1.1:1 and about 1.5:1.
